(19) United States
(12) Patent Application Publication
(10) Pub. No.: US 2020/0106515 A1
(43) Pub. Date: Apr. 2, 2020

(54) Communication Device, Relay Device, Information Processing System, Communication System and Communication Method

(71) Applicant: Yamaha Corporation, Hamamatsu-shi (JP)

(72) Inventor: Suguru YOSHIDA, Yaizu-shi (JP)

(21) Appl. No.: 16/700,442

(22) Filed: Dec. 2, 2019

Related U.S. Application Data
(63) Continuation of application No. PCT/JP2018/010565, filed on Mar. 16, 2018.

(30) Foreign Application Priority Data
Jun. 6, 2017 (JP) PCT/JP2017/020999

(51) Int. Cl. H04B 7/155; H04L 12/801; H04L 12/773; H04L 29/06; H04L 29/08

(52) U.S. Cl. CPC H04B 7/1555; H04L 47/193; H04L 45/60; H04L 67/42; H04L 69/16; H04L 67/02; H04L 63/029

(57) ABSTRACT

A communication system includes a storage device, a management device, a transfer device, a relay device, and a router. The management device is configured to communicate with the storage device. The transfer device is configured to communicate with the management device. The relay device is configured to communicate with the transfer device. The router is configured to communicate with the relay device and has one or more processors, and one or more memories. The one or more processors are also caused to obtain content corresponding to the second request from a memory having content stored thereon. The one or more processors are also caused to transmit, to the relay device, content corresponding to the second request through the communication channel established with the relay device.

### CROSS REFERENCE TO RELATED APPLICATIONS

This application is based upon and claims the benefit of priority from the prior PCT Application No. PCT/JP2017/020999 filed on Jun. 6, 2017 and PCT Application No. PCT/JP2018/010565 filed on Mar. 16, 2018, the entire contents of which are incorporated herein by reference.

### FIELD

The embodiments of the present invention relate to a communication device, a relay device, an information processing system, a communication system, and a communication method.

### BACKGROUND

There has been known a remote access technology with which to access a closed network such as an intranet via the Internet. A key to remote access is to solve security problems such as information leaks. In an existing system, a first PC (personal computer) accesses a relay management server via the Internet and thereby operates a second PC within an intranet. The first PC accesses the relay management server with an external storage medium connected to the first PC, and the external storage medium has stored thereon software for operating the second PC and authentication information. In a case where the relay management server has authenticated the first PC on the basis of the authentication information, the relay management server permits the first PC to operate the second PC.

### SUMMARY

According to an embodiment of the present invention, there is provided a communication device including: a transmitting unit configured to transmit, to a relay device configured to relay communication between a client and the communication device, a first request for establishment of a communication channel with the communication device; and a receiving unit configured to receive a second request transmitted by the client from the relay device through the communication channel thus established.

According to an embodiment of the present invention, there is provided a relay device for relaying communication between a client and a communication device, the relay device including: a first receiving unit configured to receive a first request from the communication device for establishment of a communication channel with the communication device; a second receiving unit configured to receive a second request for content transmitted by the client; and a transfer unit configured to transfer the second request thus received to the communication device through the communication channel thus established.

According to an embodiment of the present invention, there is provided an information processing system including: the relay device; a third receiving unit configured to receive login information from the client; a login information storage unit configured to store therein the login information thus received; a fourth receiving unit configured to receive the second request from the client; a determination unit configured to determines, on the basis of the second request received from the client and the login information thus stored, whether transfer of the second request to the relay device is possible or impossible; and a transfer unit configured to, in a case where the determination unit has determined that the transfer is possible, transfer the second request thus received to the relay device.

According to an embodiment of the present invention, there is provided a communication system including: the communication device; and the relay device.

According to an embodiment of the present invention, there is provided a communication system including: the communication device; and the information processing system.

According to an embodiment of the present invention, there is provided a communication method including: transmitting, to a relay device configured to relay communication between a client and the communication device, a first request for establishment of a communication channel with the communication device; and receiving a second request transmitted by the client from the relay device through the communication channel thus established.

According to an embodiment of the present invention, there are provided a program for causing a computer to execute operations including: transmitting, to a relay device configured to relay communication between a client and the communication device, a first request for establishment of a communication channel with the communication device; and receiving a second request transmitted by the client from the relay device through the communication channel thus established, and a computer-readable recording medium having stored thereon the program.

The embodiments of the present invention make it possible to provide a technology for, with a particular client as a partner, receiving a request from the client.

### BRIEF EXPLANATION OF DRAWINGS

FIG. 1 is a block diagram showing an overall configuration of a communication system;

FIG. 2 is a block diagram showing an example of a physical configuration of a management system;

FIG. 3 is a block diagram showing an example of a physical configuration of a relay device;

FIG. 4 is a diagram showing an example of a configuration of a transfer management table;

FIG. 5 is a block diagram showing an example of a configuration of a router;

FIG. 6 is a block diagram showing an example of a functional configuration of a communication system;

FIG. 7 is a sequence chart showing an example of the flow of a process that is executed by the communication system;

FIG. 8 is a sequence chart showing an example of the flow of the process that is executed by the communication system;

FIG. 9 is a sequence chart showing an example of the flow of the process that is executed by the communication system;

FIG. 10 is a diagram showing an example of a GUI of the router;

FIG. 11 is a sequence chart showing an example of the flow of a process that is executed by a communication system;

FIG. 12 is a block diagram showing an example of a configuration of a router;

FIG. 13 is a sequence chart showing an example of the flow of a process that is executed by the communication system;

FIG. 14 is a sequence chart showing an example of the flow of a content transfer process that is executed by the communication system;

FIG. 15 is a sequence chart showing an example of the flow of a communication channel management process that is executed by the communication system;

FIG. 16 is a block diagram showing a configuration of a communication device; and

FIG. 17 is a block diagram showing a configuration of a relay device.

### DESCRIPTION OF EMBODIMENTS

In an existing communication device, the relay management server establishes a session with the first PC, to which the external storage medium is connected, and a session with the second PC, which is operated, and relays information for operating the second PC.

On the other hand, the embodiments of the present invention have as an object to provide a technology for, with a particular client as a partner, receiving a request from the client.

Embodiments of the present invention are described in detail below with reference to the drawings. The embodiments to be hereinafter prescribed are examples of embodiments of the present invention, and the present invention is not limited to these embodiments. It should be noted that in the drawings that are referred to in the present embodiment, identical parts or parts having the same functions are given identical signs or similar signs and a repeated description thereof may be omitted.

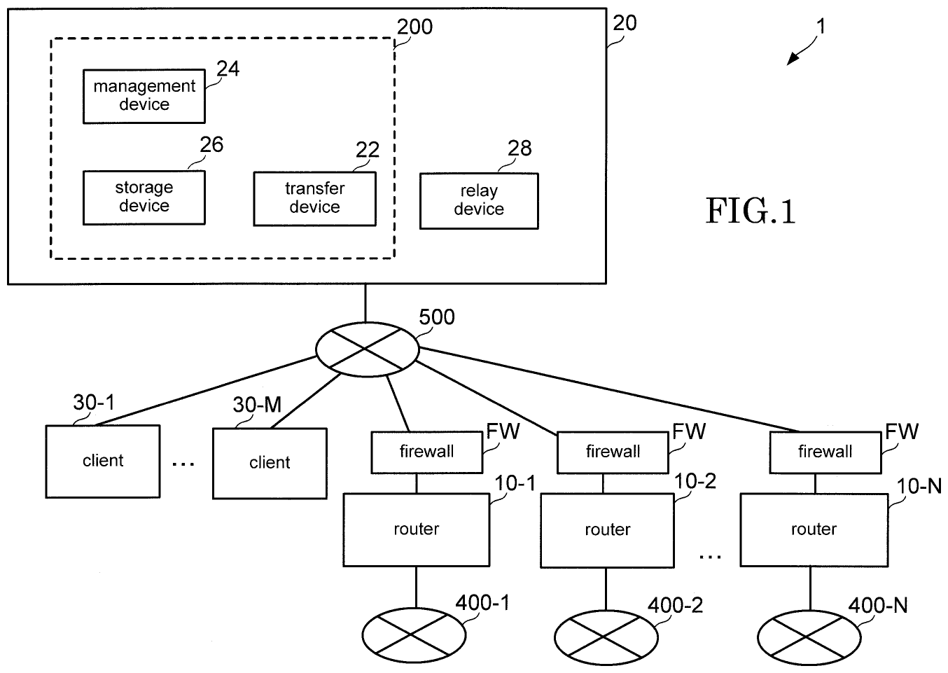

FIG. 1 is a block diagram showing an overall configuration of a communication system 1 according to an embodiment of the present invention. The communication system 1 includes a plurality of routers 10-1, 10-2, . . . , and 10-N (where N is a natural number) and an information processing system 20. The information processing system 20 is a system for performing information processing for remotely controlling the plurality of routers 10-1, 10-2, . . . , and 10-N.

A router 10-i (where i is a natural number. Note, however, that 1≤i≤N) is connected to a first network 400-i and a second network 500 by cable or by radio. The plurality of routers 10-1, 10-2, . . . , and 10-N communicate with the second network 500 via firewalls FW, respectively. The router 10-i is a communication device that performs data transfer between the first network 400-i and the second network 500. The data transfer function is compatible with the TCP (Transmission Control Protocol)/IP protocol. The data transfer function may include a routing function of making an appropriate route choice.

The firewalls FW permit communication by opening particular ports or prohibit communication by closing particular ports. The firewalls FW include stateful inspection functions. The firewalls FW have HTTP (Hypertext Transfer Protocol) ports opened in advance toward at least the plurality of routers 10-1, 10-2, . . . , and 10-N. The firewalls FW have ports closed in advance toward the second network 500. In the present embodiment, the firewalls FW are provided outside the routers 10. Alternatively, the firewalls FW may be implemented as functions of the routers 10.

When the first networks 400-1, 400-2, . . . , and 400-N are not distinguished from one another, they are collectively referred to as “first network 400”. When the plurality of routers 10-1, 10-2, . . . , and 10-N are not distinguished from one another, they are collectively referred to as “router 10”.

The first network 400 is for example a network built within an organization such as a corporate or a school. The first network 400 is for example an intranet, which is an example of a closed network. The intranet is for example a LAN (local area network). The first network 400 is connected to a communication terminal device (not illustrated) by cable or by radio. The communication terminal device is for example a switch (e.g. an L2 switch, an L3 switch, or an application switch), an access point, or a user terminal (e.g. a PC, a smartphone, or a tablet computer). Note, however, that the communication terminal device may be a device other than these.

The second network 500 is a network built in a geographically wider area than the first networks 400. The second network 500 is for example the Internet or a WAN (wide area network). The second network 500 is connected to the information processing system 20 and each of a plurality of clients 30-1, . . . , and 30-M as well as the plurality of routers 10-1, 10-2, . . . , and 10-N by cable or by radio. When the plurality of clients 30-1, . . . , and 30-M are not distinguished from one another, they are collectively referred to as “client 30”.

The client 30 is a computer device that is used by a user. The client 30 communicates with the information processing system 20 via the second network 500. The client 30 is for example a PC, a smartphone, or a tablet computer but may be a device other than these.

The router 10 functions as a server device that provides the client 30 with content in response to a request from the client 30. The content is content pertaining to the data transfer function of the router 10. In the present embodiment, the content is a graphical user interface (hereinafter referred to as “GUI”) of the router 10. The GUI includes, for example, information pertaining to a terminal device connected to the router 10 (e.g. the name of the device, the name of the manufacturer, or the OS (operating system), the IP address, or a comment) and information pertaining to the topology of the router 10 (e.g. the connection configuration of the terminal device).

The router 10 and the client 30 perform communication with each other via the information processing system 20. The information processing system 20 includes a management system 200 and a relay device 28.

The management system 200 includes a transfer device 22, a management device 24, and a storage device 26. The transfer device 22 relays data that is transmitted and received among the second network 500, the management device 24, the storage device 26, and the relay device 28. In the present embodiment, the transfer device 22 is a reverse proxy server that performs URL (uniform resource locator) routing. The URL routing is a data transfer method by which to select a forwarding destination of data on the basis of a URL.

The management device 24 is a server device that performs user management of the client 30 and management of the router 10.

The storage device 26 stores data therein in accordance with an instruction from the management device 24. The storage device 26 is for example a cache server.

The relay device 28 relays data that is transmitted and received between the transfer device 22 and each of the plurality of routers 10-1, 10-2, . . . and 10-N. The relay device 28 is for example a server device.

In the present embodiment, the transfer device 22, the management device 24, and the storage device 26 are physically separated from one another. Alternatively, they may be replaced by a single device having the functions of some or all of them.

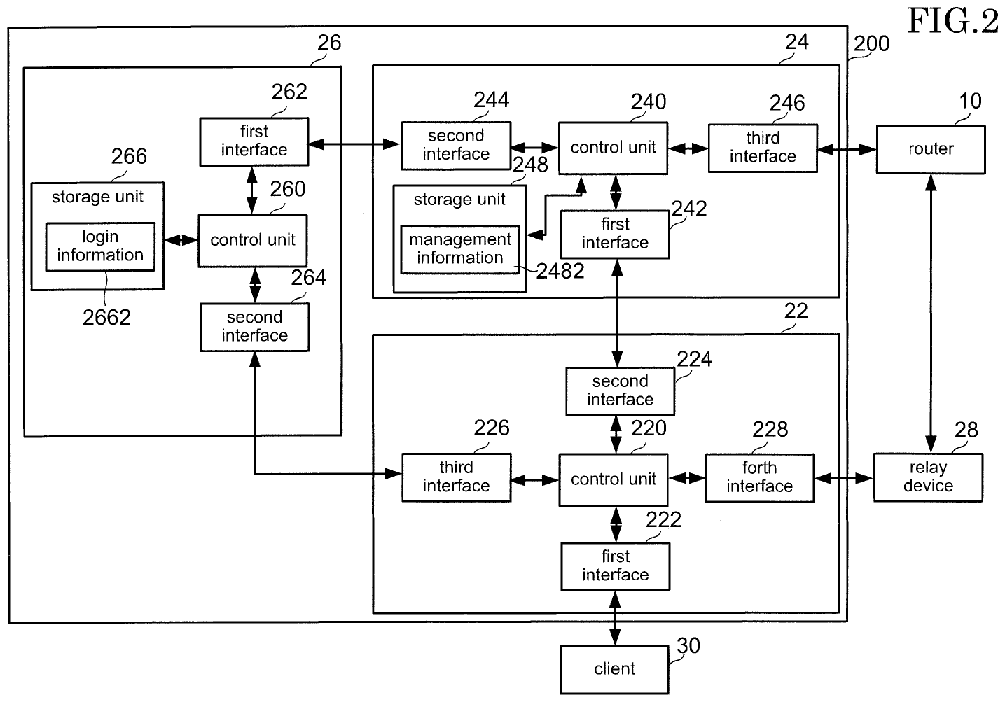

FIG. 2 is a block diagram showing an example of a physical configuration of the management system 200. The transfer device 22 includes a control unit 220, a first interface 222, a second interface 224, a third interface 226, and a fourth interface 228. The control unit 220 controls each component of the transfer device 22. The first interface 222 is an interface for communicating with the client 30. The second interface 224 is an interface for communicating with the management device 24. The third interface 226 is an interface for communicating with the storage device 26. The fourth interface 228 is an interface for communicating with the relay device 28. The control unit 220 performs URL routing through the first interface 222, the second interface 224, and the fourth interface 228. Further, the control unit 220 performs communication with the storage device 26 through the third interface 226 in accordance with a predetermined protocol.

The management device 24 includes a control unit 240, a first interface 242, a second interface 244, a third interface 246, and a storage unit 248. The control unit 240 controls each component of the management device 24. The first interface 242 is an interface for communicating with the transfer device 22. The second interface 244 is an interface for communicating with the storage device 26. The third interface 246 is an interface for communicating with the client 30. The storage unit 248 stores data therein. The storage unit 248 stores, for example, management information 2482 therein.

The management information 2482 includes login information for each user as information pertaining to the user management of the client 30. The login information is user-specific information that is used for logging in to the management device 24. The login information includes, for example, an ID and a password but may include information other than these. The management information 2482 may further include information for managing the authority of a user of the client 30 to view and operate the GUI. The management information 2482 includes, as information for managing the router 10, the serial number of the router 10 placed under the management of the management system 200. The serial number is identification information for identifying each of the routers 10-1, 10-2, . . . , and 10-N. The serial number may be replaced by another piece of identification information of the router 10.

The storage device 26 includes a control unit 260, a first interface 262, a second interface 264, and a storage unit 266. The control unit 260 controls each component of the storage device 26. The first interface 262 is an interface for communicating with the management device 24. The second interface 264 is an interface for communicating with the transfer device 22. The storage unit 266 stores data therein. The storage unit 266 stores, for example, login information 2662 therein. The login information 2662 is login information used by the client 30 logging in to the management system 200.

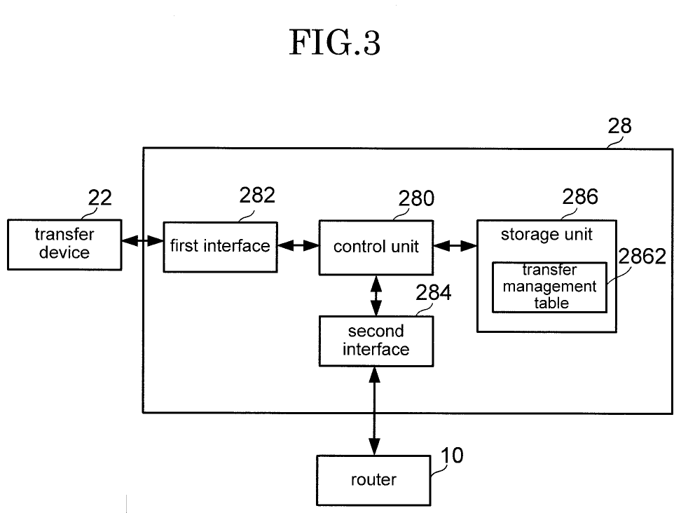

FIG. 3 is a block diagram showing an example of a physical configuration of the relay device 28. The relay device 28 includes a control unit 280, a first interface 282, a second interface 284, and a storage unit 286. The control unit 280 controls each component of the relay device 28. The first interface 282 is an interface for communicating with the transfer device 22. The second interface 284 is an interface for communicating with the router 10. The storage unit 286 stores data therein. The storage unit 286 stores, for example, a transfer management table 2862 therein.

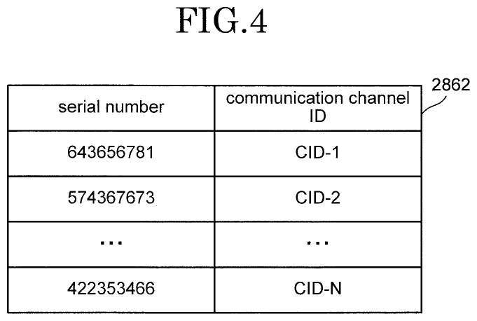

FIG. 4 is a diagram showing an example of a configuration of the transfer management table 2862. The transfer management table 2862 is a table in which for a router 10 whose communication channel with the relay device 28 has been established, the serial number of the router 10 and a communication channel ID for identifying the communication channel are stored in association with each other. In this example, the serial number is expressed by a nine-digit number. The number of digits may be different, or letters such as those of the alphabet may be used. The communication channel ID is identification information for identifying the communication channel established between the relay device 28 and the router 10. In the present embodiment, the communication channel ID of a communication channel established between the relay device 28 and a router 10-i is denoted as “CID-i”.

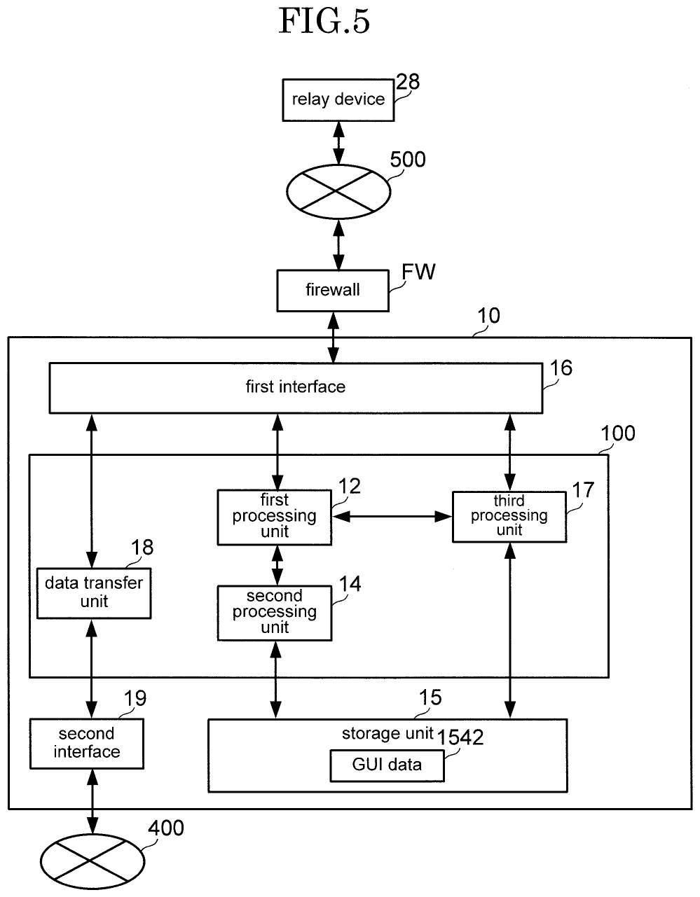

FIG. 5 is a block diagram showing an example of a configuration of the router 10. The router 10 includes a control unit 100, a storage unit 15, a first interface 16, and a second interface 19 as physical components.

The control unit 100 controls each component of the router 10. The storage unit 15 stores data therein. The storage unit 15 stores therein, for example, GUI data 1542 serving as data for displaying the GUI. The first interface 16 is an interface for communicating with the second network 500. A communication channel between the first interface 16 and the second network 500 goes through the firewall FW. The second interface 19 is an interface for communicating with the first network 400.

The control unit 100 includes a first processing unit 12, a second processing unit 14, a third processing unit 17, and a data transfer unit 18. Upon receiving an HTTP request through the first interface 16, the first processing unit 12 transfers the HTTP request to the second processing unit 14. Further, upon receiving an HTTP response from the second processing unit 14, the first processing unit 12 transfers the HTTP response to the relay device 28 through the first interface 16. The second processing unit 14 exercises control pertaining to an HTTPD (HTTP daemon) as a daemon. Upon receiving an HTTP request, the second processing unit 14 transmits, to the first processing unit 12, an HTTP response corresponding to the HTTP request. The third processing unit 17 performs a process pertaining to a router function (e.g. a function of the data transfer unit 18). The third processing unit 17 for example accesses the management system 200 through the first interface 16 and manages information pertaining to the router 10. The data transfer unit 18 transfers data between the first network 400 and the second network 500 through the first interface 16 and the second interface 19.

The first processing unit 12, the second processing unit 14, the third processing unit 17, and the data transfer unit 18 are each achieved, for example, by software and hardware that executes the software. The first processing unit 12 and the second processing unit 14 perform, for example, socket communication with each other. The first processing unit 12 and the second processing unit 14 for example establish a TCP session as a communication channel and perform communication with each other in accordance with TCP/IP. The first processing unit 12 and the third processing unit 17 perform interprocess communication with each other. Another scheme may be used as a scheme for communication among the components of the control unit 100. Further, some or all of the first processing unit 12, the second processing unit 14, the third processing unit 17, and the data transfer unit 18 may be achieved solely by hardware.

The control unit of each of the devices described above includes an arithmetic processing device exemplified by a CPU (central processing unit) and a processor mounted with a memory exemplified by a ROM (read-only memory) and a RAM (random-access memory). The interfaces each include, for example, a modem or an NIC (network interface card). The control unit transmits and receives data through the interfaces. The storage unit is a storage medium such as a magnetic recording medium (such as a magnetic tape or a magnetic disk), an optical recording medium, a magneto-optical recording medium, or a semiconductor memory.

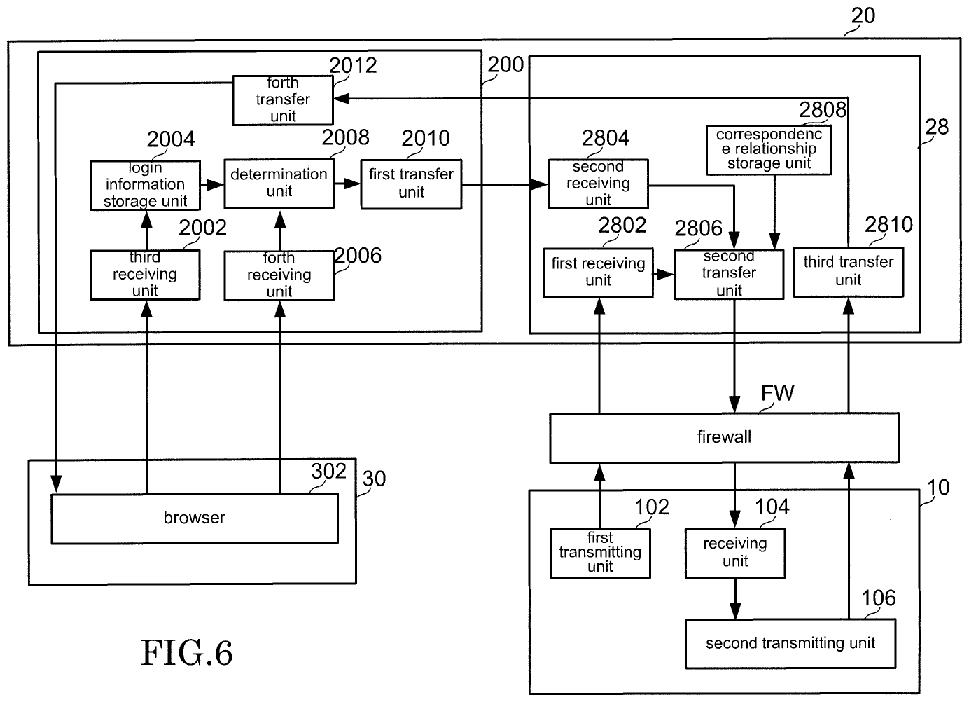

FIG. 6 is a block diagram showing an example of a functional configuration of the communication system 1. Each of the functions to be described below is achieved by hardware, software, or a combination of hardware and software.

In the router 10, a first transmitting unit 102 transmits a first request to the relay device 28 for the establishment of a communication channel with the router 10. The phrase “establishment of a communication channel” refers to making it possible to transmit and receive data to and from a particular partner. The first transmitting unit 102 transmits a first request to the relay device 28, for example, upon activation of the router 10. The first transmitting unit 102 is achieved, for example, by the first processing unit 12 and the first interface 16.

In the relay device 28, a first receiving unit 2802 receives a first request from the router 10. A communication channel is established between the router 10 and the relay device 28 in response to a first request received by the first receiving unit 2802. The first receiving unit 2802 is achieved, for example, by the control unit 280 and the second interface 284 of the relay device 28.

In the client 30, a browser 302 transmits login information to the management system 200. In the management system 200, a third receiving unit 2002 receives login information from the browser 302. The third receiving unit 2002 is achieved, for example, by the transfer device 22 and the control unit 240 and the first interface 242 of the management device 24.

A login information storage unit 2004 stores therein login information received by the third receiving unit 2002. The login information storage unit 2004 is achieved, for example, by the control unit 260 and the storage unit 266, which stores the login information 2662 therein, of the storage device 26.

While the client 30 is logging into the management system 200, the browser 302 transmits a second request to the management system 200 for content. A second request contains, for example, information for identifying the serial number of the router 10 and login information. In the management system 200, a fourth receiving unit 2006 receives a second request from the browser 302. The fourth receiving unit 2006 is achieved, for example, by the control unit 220 and the first interface 222 of the transfer device 22.

A determination unit 2008 determines, on the basis of a second request received by the fourth receiving unit 2006 and login information stored in the login information storage unit 2004, whether the transfer of the second request to the relay device 28 is possible or impossible. In a case where a second request has been received from the browser 302 during login, the determination unit 2008 determines that the transfer is possible. The determination unit 2008 determines, for example, on the basis of correspondence between information stored in the second request and login information stored in the login information storage unit 2004 (e.g. whether they match), whether the transfer is possible or impossible. The determination unit 2008 is achieved, for example, by the control unit 220 of the transfer device 22.

In a case where it has been determined by the determination unit 2008 that the transfer is possible, a first transfer unit 2010 transfers a second request received by the fourth receiving unit 2006 to the relay device 28. The first transfer unit 2010 is achieved, for example, by the control unit 220 and the fourth interface 228 of the transfer device 22.

In the relay device 28, a second receiving unit 2804 receives a second request transferred by the first transfer unit 2010. The second receiving unit 2804 is achieved, for example, by the control unit 280 and the first interface 282 of the relay device 28.

A second transfer unit 2806 transfers, to the router 10, a second request transmitted by the client 30 and received by the second receiving unit 2804. A correspondence relationship storage unit 2808 stores therein data indicating a correspondence relationship between each of the plurality of routers 10 and a communication channel established between the relay device 28 and the router 10. The second transfer unit 2806 selects a communication channel for use in the transfer of a second request on the basis of the serial number of the router 10 contained in the second request and a correspondence relationship stored in the correspondence relationship storage unit 2808. The second transfer unit 2806 is achieved, for example, by the control unit 280 and the second interface 284. The correspondence relationship storage unit 2808 is achieved by the storage unit 286, which stores the transfer management table 2862 therein.

In the router 10, a receiving unit 104 receives a second request from the relay device 28 through a communication channel established on the basis of a first request. The receiving unit 104 is achieved by the first processing unit 12 and the first interface 16.

A second transmitting unit 106 transmits, to the relay device 28, content corresponding to a second request received. The second transmitting unit 106 is achieved by the second processing unit 14, the interface 142, and the storage unit 15, which stores the GUI data 1542 therein.

In the relay device 28, a third transfer unit 2810 transfers, to the management system 200, content transmitted by the second transmitting unit 106. The third transmitting unit 2810 is achieved, for example, by the control unit 280, the first interface 282, and the second interface 284.

In the management system 200, a fourth transfer unit 2102 further transfers, to the client 30, content transferred by the third transfer unit 2810. The client 30 is a source of transmission of a second request. The fourth transfer unit 2012 is achieved, for example, by the control unit 220, the fourth interface 228, and the first interface 222. The browser 302 of the client 30 receives content from the transfer device 22.

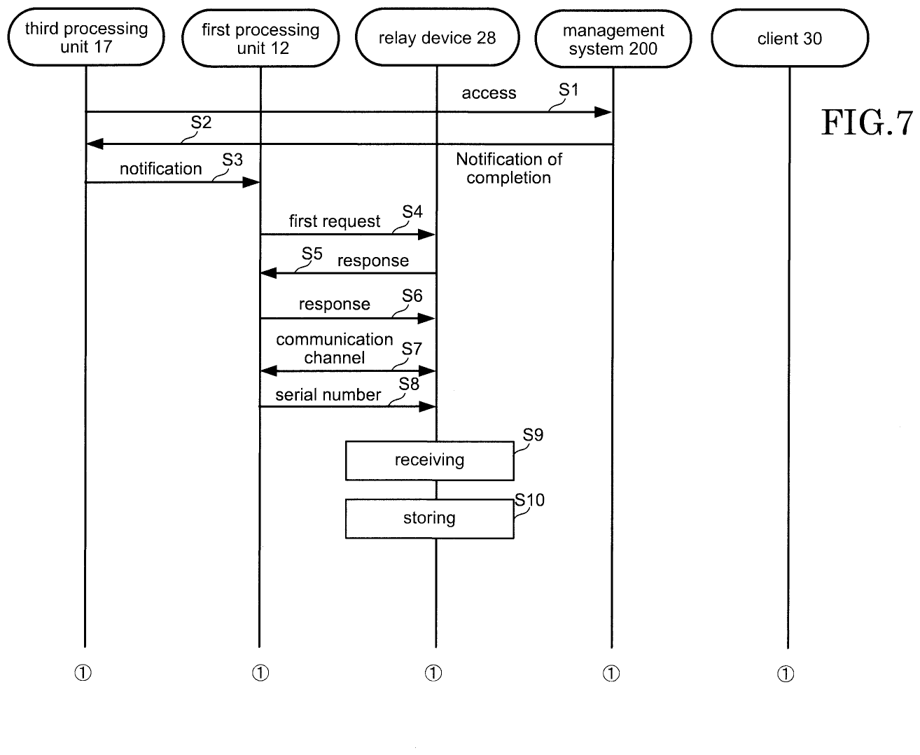

FIGS. 7, 8, and 9 are sequence charts showing an example of the flow of a process that is executed by the communication system 1. As shown in FIG. 7, first, in the router 10, the third processing unit 17 accesses the management device 24 through the first interface 16 (step S1). The third processing unit 17 performs the access of step S1 so that the router 10 is placed under the management of the management device 24. During the access of step S1, the third processing unit 17 transmits the serial number of the router 10. The first processing unit 12 access the management device 24, for example, upon activation of the router 10. The phrase “upon activation of the router 10” refers to a case where the router 10 has been powered on and a case where the router 10 has been reactivated in response to a predetermined operation (e.g. a reset operation) after the router 10 was powered on.

In response to the access from the router 10, the management device 24 executes a process for placing the router 10 under management. For example, the management device 24 updates the management information 2482. The management device 24 adds the serial number of the router 10 to the management information 2482. Upon completion of the process, the management device 24 transmits a notification of completion to the third processing unit 17 of the router 10 (step S2). The third processing unit 17 notifies the first processing unit 12 of the completion of the process for placing the router 10 under management (step S3).

Next, in the router 10, the first processing unit 12 (first transmitting unit 102) transmits a first request to the relay device 28 for the establishment of a communication channel with the router 10 (step S4). The first processing unit 12 transmits the first request so that the router 10 serves as a starter for the establishment of the communication channel upon activation of the router 10. The first processing unit 12 may transmit the first request using, as a trigger, reception by the router 10 of the notification of completion of step S2. The communication channel here is a TCP session. In this case, the first request is equivalent to the SYN of three-way handshaking.

Upon receiving the first request, the relay device 28 (first receiving unit 2802) transmits a response to the router 10 to the effect that the request for the establishment of the communication channel has been accepted and to the effect that the establishment of the communication channel is requested (step S5). This response is equivalent to the SYN_ACK of three-way handshaking. The response to the first request transmitted by the first transmitting unit 102 is equivalent to a second request. Accordingly, the firewall FW temporarily opens the HTTP port and transfers, to the router 10, the data transmitted in step S5. Next, the router 10 (first transmitting unit 102) transmits, to the relay device 28, a response that permits the establishment of the communication channel (step S6). This response is equivalent to the ACK of three-way handshaking. This causes the communication channel to be established via the firewall FW between the router 10 and the relay device 28 (step S7). Next, the router 10 (first transmitting unit 102) transmits the serial number of the router 10 to the relay device 28 (step S8). The relay device 28 (first receiving unit 2802) receives the serial number and causes the storage unit 286 to store the serial number therein (steps S9 and S10).

The communication channel between the router 10 and the relay device 28 is kept established. In case of unintended interruption of the communication channel due to a timeout or the like, the router 10 may serve as a starter to establish the communication channel again.

Further, the relay device 28 has a communication channel for each router 10 placed under the management of the management device 24. Once a communication channel is established, the relay device 28 stores the serial number of the router 10 and a communication channel ID for identifying the communication channel established between the router 10 and the relay device 28 in association with each other in the transfer management table 2862.

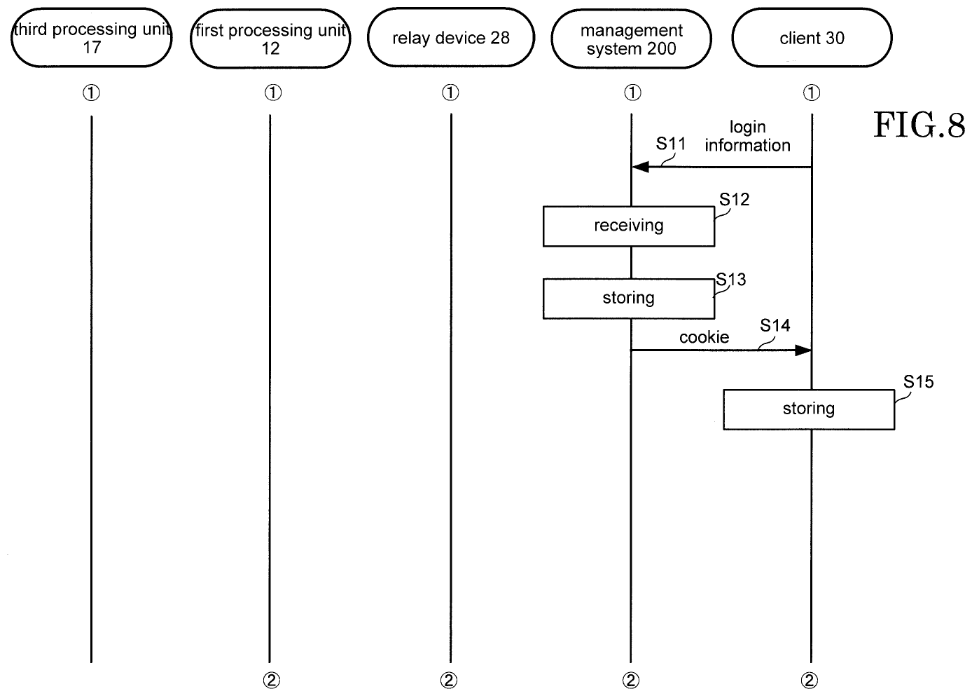

As shown in FIG. 8, in an attempt to log in to the management system 200, the client 30 (browser 302) transmits login information to the management system 200 (step S11). The transmission of the login information is executed in accordance with an instruction from the user of the client 30.

In the management system 200, the management device 24 (third receiving unit 2002) receives the login information from the client 30 (step S12). The transfer device 22 transfers the login information to the management device 24 on the basis of a URL that the client 30 used in the transmission of the login information. The management device 24 receives this login information.

The storage device 26 (login information storage unit 2004) stores therein the login information 2662 received by the management information 24 (step S13). Specifically, the management device 24 instructs the storage device 26 to store therein the login information thus received. In accordance with this instruction, the storage device 26 keeps the login information 2662 stored therein while the client 30 is logging in. Once the client 30 logs out, the storage device 26 may delete the login information 2662 from the storage unit 266.

The management device 24 transmits, to the client 30, a cookie for identifying the login information 2662 (step S14). The cookie contains information for identifying the login information 2662. The client 30 stores therein the cookie thus received (step S15).

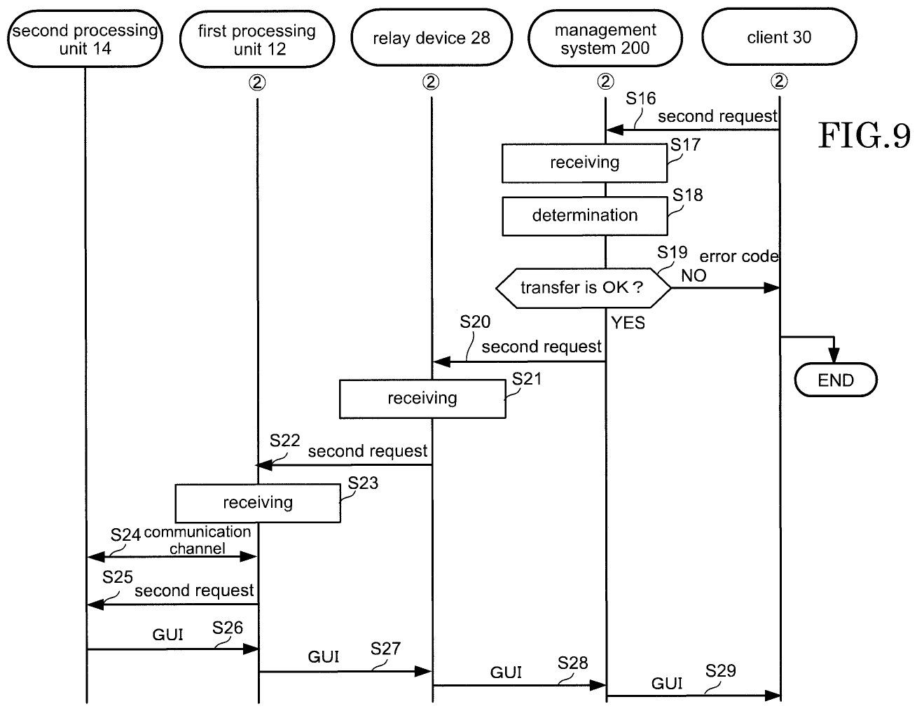

As shown in FIG. 9, while logging in to the management device 24, the client 30 transmits a second request to the management system 200 for the GUI of the router 10 (step S16). The second request is an HTTP request containing the cookie stored in step S15.

The management device 24 (fourth receiving unit 2006) receives this second request (step S17). For example, the management device 24 transmits, to the client 30, a web page configured such that any router 10 can be selected from among the plurality of routers 10. This web page contains a hyperlink designating a unique URL for each router 10. Further, the URL is in such a form that the serial number of the corresponding router 10 can be identified. In a case where the serial number is “643656781”, the URL is for example in the form “http://xx.com/gfw/?serial=64365678”. The character “?” is a delimiter. The character string “gfw” is an identifier that is used to determine whether to transfer the request to the relay device 28. Instead of containing the serial number per se, the URL may contain a character that indirectly identifies the serial number (e.g. a character string into which the serial number has been converted in accordance with a predetermined rule).

Next, the transfer device 22 (determination unit 2008) determines, on the basis of the second request received from the client 30 and the login information 2662 stored in the storage device 26, whether the transfer of the second request to the relay device 28 is possible or impossible (step S18). For example, in a case where the login information identified by the cookie matches the login information 2662 stored in the storage unit 266, the transfer device 22 determines that the transfer is possible (step S19; YES). This is because the second request is rendered transferable in a case where the client 30 is logging in. On the other hand, in a case where the login information identified by the cookie does not match the login information 2662 stored in the storage unit 266, the transfer device 22 determines that the transfer is impossible (step S19; NO). In a case where the transfer device 22 has determined that the transfer is impossible, the transfer device 22 transmits an error message to the client 30. The client 30 displays the error message through the browser 302. In this case, the process of FIGS. 7 to 9 ends without the client 30 being provided with the GUI of the router 10.

In a case where the transfer device 22 has determined that the transfer is possible, the transfer device 22 (first transfer unit 2010) transfers the second request to the relay device 28 (step S20). The transfer device 22 may transfer the second request after extracting the serial number from the second request and adding it to an HTTP header. The relay device 28 (second receiving unit 2804) receives the second request from the transfer device 22 (step S21). The relay device 28 (second transfer unit 2806) selects a communication channel for use in the transfer of the second request on the basis of the second request and the transfer management table 2862 and transfers the second request to the router 10 (step S22). The HTTP header of the second request contains the serial number. The relay device 28 refers to the transfer management table 2862 and transfers the second request to the router 10 through a communication channel indicated by a communication channel ID associated with the serial number. In a case where the serial number is “643656781”, the relay device 28 transfers the second request to the router 10-1 through a communication channel whose communication channel ID is “CID-1”.

In the router 10, the first processing unit 12 (receiving unit 104) receives the second request from the relay device 28 through the communication channel established in step S6 (step S23).

Upon receiving the second request, the first processing unit 12 establishes a communication channel with the second processing unit 14 (step S24). The communication channel is for example a TCP session and is established by a technique such as three-way handshaking. The first processing unit 12 transfers the second request to the second processing unit 14 through the communication channel thus established (step S25).

Upon receiving the second request, the second processing unit 14 transmits a GUI corresponding to the second request to the first processing unit 12 on the basis of the GUI data 1542 by means of an HTTP response (step S26). Upon receiving the GUI from the second processing unit 14, the first processing unit 12 transfers the GUI to the relay device 28 (step S27). Upon receiving the GUI from the first processing unit 12, the relay device 28 (third transfer unit 2810) transfers the GUI to the management system 200 (step S28). Upon receiving the GUI from the relay device 28, the transfer device 22 (fourth transfer unit 2012) of the management system 200 transfers the GUI to the client 30 (step S29). Upon receiving the GUI, the client 30 displays the GUI through the browser 302.

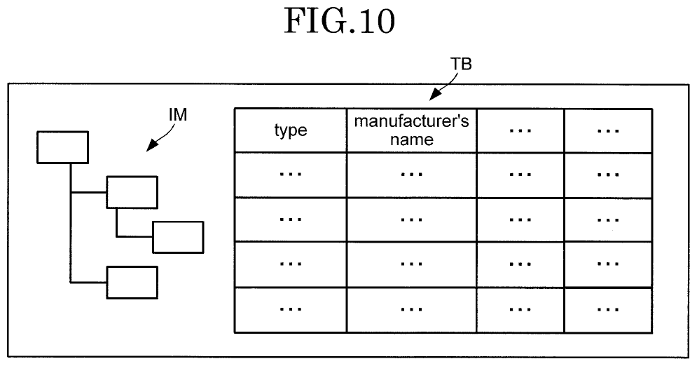

FIG. 10 shows an example of the GUI of the router 10. As shown in FIG. 10, the GUI contains an image IM representing a topology of the router 10 and a table TB listing information pertaining to the router 10 such as the type of communication equipment and the manufacturer's name. The GUI shown in FIG. 10 is just an example. For example, another piece of information may be displayed, or the GUI may be different in screen structure.

In a case where the communication system 1 adopts HTTP 1.0, the TCP sessions are disconnected when an HTTP request and an HTTP response have been transmitted once. That is, every time the process described with reference to FIGS. 7 to 9 is completed, the communication channels are disconnected. Specifically, first, the second processing unit 14 disconnects the communication channel with the first processing unit 12. Next, the first processing unit 12 disconnects the communication channel with the relay device 28. Next, the relay device 28 disconnects the communication channel with the transfer device 22. Then, the transfer device 22 disconnects the communication channel with the client 30.

In a case where the communication channels have been thus disconnected, the first processing unit 12 serves as a starter again to transmit a first request to the relay device 28 for the establishment of a communication channel. This enables the communication system 1 to perform step S7 and the subsequent steps again.

In a case where the communication system 1 adopts HTTP 1.1, an HTTP request and an HTTP response can be transmitted more than once through the TCP sessions once established.

According to the embodiment described above, the router 10 serves as a starter for the establishment of a communication channel to establish a communication channel with the relay device 28 by transmitting a first request to the relay device 28. The router 10 uses this communication channel to receive a second request via the relay device 28. By the router 10 serving as a starter for the establishment of a communication channel, a communication channel can be established with a communication partner as the relay device 28. Further, the router 10 can provide a client 30 to which the relay device 28 has relayed a second request with a GUI corresponding to the second request. Accordingly, the router 10, which has a function as a daemon, can treat a particular client 30 as a partner, receive a second request from the client 30, and provide a GUI corresponding to the second request. Further, even in a case where the firewall FW closes a relay device 28 side port at normal times so that no request is accepted from the second network 500, the router 10 can provide the client 30 with a GUI. This ensures the security of the router 10.

Further, the transfer device 22 performs URL routing to transfer login information and a second request from the client 30 to appropriate forwarding destinations, respectively. The client 30 can acquire a GUI of the router 10 through the browser 302. Accordingly, the client 30 does not need to be installed, for example, with dedicated software.

The aforementioned embodiment may be combined or replaced with another embodiment for application. Further, the aforementioned embodiment may be modified in the following manner for implementation.

For example, in a case where HTTP 1.0 is adopted, the communication channels are disconnected when an HTTP request and an HTTP response have been transmitted once. After that, the router 10 establishes the communication channels again. Thus, there is a possibility that the relay device 28 may receive a second request in a period during which there is no communication channel established between the relay device 28 and the router 10. To address this problem, the relay device 28 may operate as described below.

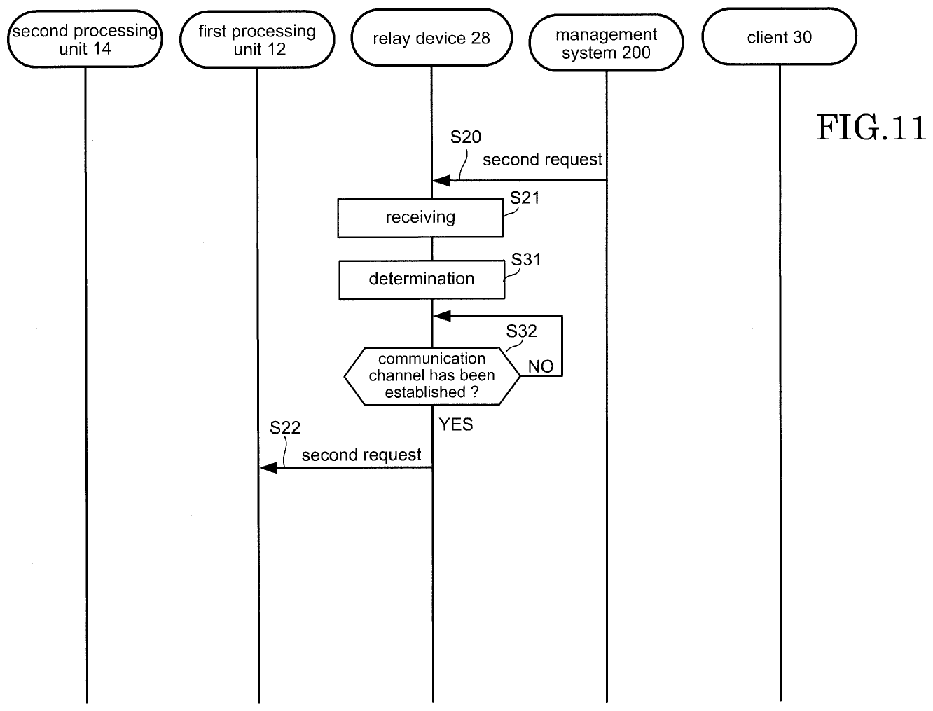

FIG. 11 is a sequence chart showing an example of the flow of a process that is executed by a communication system according to the present modification. Steps S1 to S21 are identical to those of the aforementioned embodiment. The relay device 28 (second receiving unit 2804) receives a second request transferred by the management system 200 (steps S20 and S21). Next, the relay device 28 (second transfer unit 2806) determines whether there is a communication channel established with a router 10 serving as a forwarding destination of the second request thus received (step S31). In a case where the relay device 28 has determined that there is no communication channel established (step S32; NO), the relay device 28 waits until a communication channel is established. After that, in a case where the relay device 28 has determined that a communication channel has been established (step S32; YES), the relay device 28 (second transfer unit 2806) transfers the second request to the router 10 as the forwarding destination (step S22). The subsequent steps may be identical to those of the aforementioned embodiment.

According to the aforementioned embodiment, in the router 10, the first processing unit 12 and the second processing unit 14 are functionally separated from each other. Such a separated configuration is suitable, for example, to a case where the first processing unit 12 is additionally mounted (e.g. added in) to a router mounted with the second processing unit 14. Alternatively, in the router 10, the first processing unit 12 and the second processing unit 14 may be functionally integrated with each other. In this case, the second processing unit 14 may perform reception of a second request and transmission of content corresponding to a second request.

The communication device of the present invention is not limited to a router. The communication device of the present invention may for example be a server device that provides content. In this case, the server device serves as a starter to establish a communication channel with a relay device, whereby a second request can be received without opening an HTTP port of the firewall FW toward the second network 500. Further, in a case where the function of the communication device of the present invention is applied to a switch or access point that is an example of the communication terminal device described in the aforementioned embodiment, the communication device of the present invention is construed as a switch or an access point. The content is not limited to a GUI but may be content such as a still image, a moving image, a voice, or a coupon.

An example of an embodiment in which a router 10 provides content containing an image taken by a camera is described here. A communication system according to the present modification is described below with a focus on points of difference from the aforementioned embodiment.

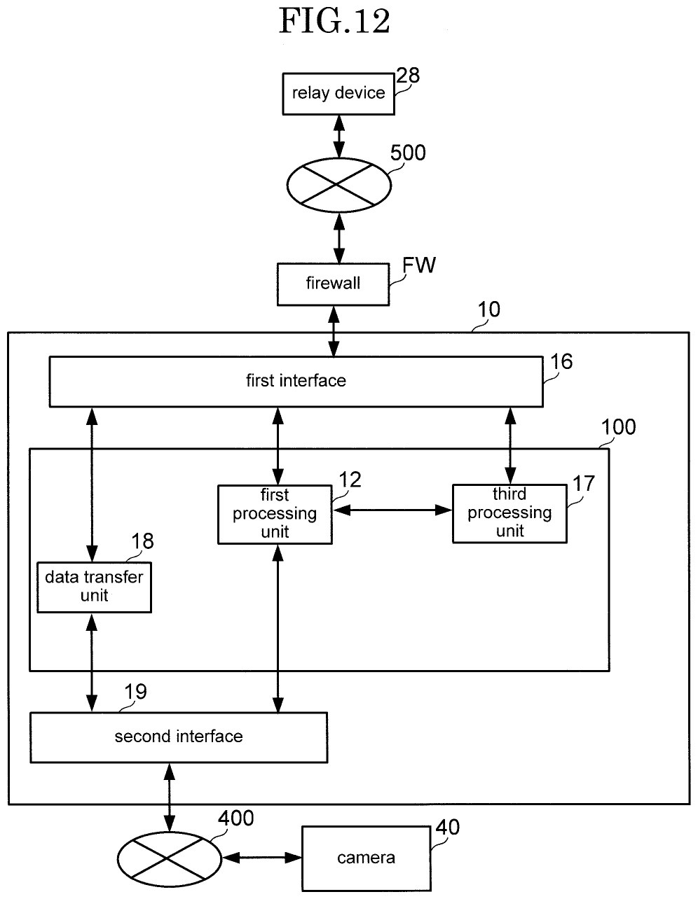

FIG. 12 is a block diagram showing an example of a configuration of a router 10 according to a modification of the present invention. Although FIG. 12 does not illustrate a second processing unit 14 or a storage unit 15, the router 10 may include a second processing unit 14 and a storage unit 15 which are identical in configuration to those of the aforementioned embodiment.

The router 10 communicates with a camera 40 via the first network 400. The camera 40 is a camera that takes a moving image. The camera 40 is for example a web camera and generates and outputs a file of a predetermined format. The file is for example in Motion-JPEG format, but the moving image may be compressed in any format. The camera 40 communicates with the first network 400 by cable or by radio. The camera 40 takes an image, for example, of a place where the first network 400 or the router 10 is used.

In the router 10, the first processing unit 12 communicates with the camera 40 through the second interface 19. The first processing unit 12 transmits, to the relay device 28, an image acquired from the camera 40 (such an image being hereinafter referred to as “camera image”). The camera image shows an image taken by the camera 40. In a case where camera images are files of Motion-JPEG format, each of the camera images shows a still image.

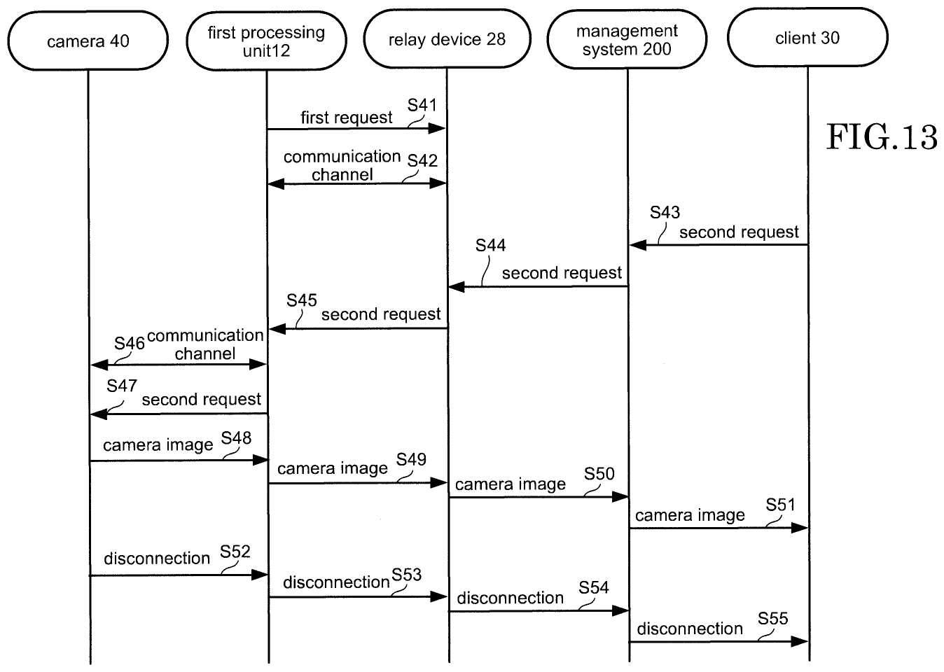

FIG. 13 is a sequence chart showing an example of the flow of a process that is executed by the communication system according to the present modification. In the router 10, the first processing unit 12 (first transmitting unit 102) transmits a first request to the relay device 28 for the establishment of a communication channel with the router 10 (step S41). In response to this first request, a communication channel is established between the router 10 and the relay device 28 (step S42). The communication channel establishment process may be identical to that of the aforementioned embodiment.

The client 30 transmits a second request to the management system 200 for a moving image taken by the camera 40 (step S43). The management system 200 transfers the second request to the relay device 28 (step S44). The relay device 28 transfers the second request to the router 10 (step S45). In the router 10, upon receiving the second request from the relay device 28 through the communication channel established in step S42, the first processing unit 12 (receiving unit 104) establishes a communication channel with the camera 40 (step S46). The communication channel is for example a TCP session and is established by a technique such as three-way handshaking. The first processing unit 12 transfers the second request to the camera 40 through the communication channel established with the camera 40 (step S47).

In response to the second request thus received, the camera 40 transmits a camera image to the first processing unit 12 (step S48). The camera image that the camera 40 transmits here is constituted by one file. Upon receiving the camera image from the camera 40, the first processing unit 12 (second transmitting unit 106) transfers the camera image to the relay device 28 (step S49). Upon receiving the camera image from the first processing unit 12, the relay device 28 transfers the camera image to the management system 200 (step S50). Upon receiving the camera image from the relay device 28, the management system 200 transfers the camera image to the client 30 (step S51). Upon receiving the camera image, the client 30 displays an image on the basis of the camera image. By successively displaying images based on the camera image, the client 30 allows the user to recognize the images as a moving image.

After having transmitted a moving image file corresponding to the second request, the camera 40 disconnects the communication channel with the first processing unit 12 (step S52). Next, the first processing unit 12 disconnects the communication channel with the relay device 28 (step S53). Next, the relay device 28 disconnects the communication channel with the transfer device 22 (step S54). Next, the management system 200 (transfer device 22) disconnects the communication channel with the client 30 (step S55).

Once the communication channels are disconnected, the first processing unit 12 transmits a first request to the relay device 28 for the establishment of a communication channel, as is the case of step S41. Repeated execution of the aforementioned process in a period during which the client 30 acquires a moving image from the camera 40 and displays it causes camera images to be sequentially provided to the client 30.

In the router 10, the first processing unit 12 (first transmitting unit 102) may perform a process that is described below.

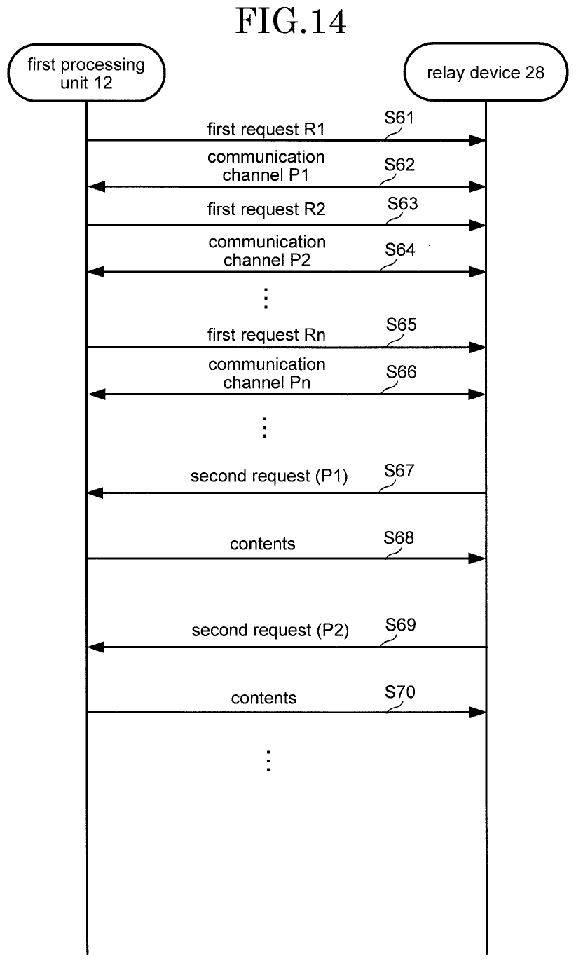

FIG. 14 is a sequence chart showing an example of the flow of a content transmission process that is executed by the communication system according to the present modification. The first processing unit 12 transmits a plurality of first requests to the relay device 28. In the following, the term “communication channel Pi” represents a communication channel that is established between the router 10 and the relay device 28 in response to a first request Ri (where i is a natural number).

The first processing unit 12 transmits a first request R1 to the relay device 28 (step S61). In response to the first request R1, a communication channel P1 is established between the router 10 and the relay device 28 (step S62). Next, the first processing unit 12 transmits a first request R2 to the relay device 28 (step S63). In response to the first request R2, a communication channel P2 is established between the router 10 and the relay device 28 (step S64). In a case where n communication channels are established, the first processing unit 12 transmits first requests R1, R2, . . . , and Rn to the relay device 28 in sequence. Although n is for example 5, it may be equal to or less than 4 or equal to or greater than 6.

After the first processing unit 12 has transmitted the first request Rn to the relay device 28 (step S65) and a communication channel Pn has been established (step S66), the first processing unit 12 stops transmitting first requests. Once step S65 is performed, the communication channels P1, P2, . . . , and Pn are established in parallel between the router 10 and the relay device 28.

In transferring a second request to the router 10, the relay device 28 transfers the second request through any communication channel selected from among the communication channels P1, P2, . . . , and Pn. For example, the relay device 28 selects the earliest established communication channel from among unselected communication channels. In this case, the relay device 28 transfers the second request through the communication channel P1 (step S67). The first processing unit 12 transmits content to the relay device 28 through the communication channel P1 in response to the second request thus received (step S68).

In transferring the next second request to the router 10, the relay device 28 transfers the second request through any communication channel selected from among the communication channels P2, . . . , and Pn. In this case, the relay device 28 transfers the second request through the communication channel P2 (step S69). The first processing unit 12 transmits content to the relay device 28 through the communication channel P2 in response to the second request thus received (step S70). In the subsequent steps, too, the transfer of a second request and content is performed through any of the communication channels established between the router 10 and the relay device 28.

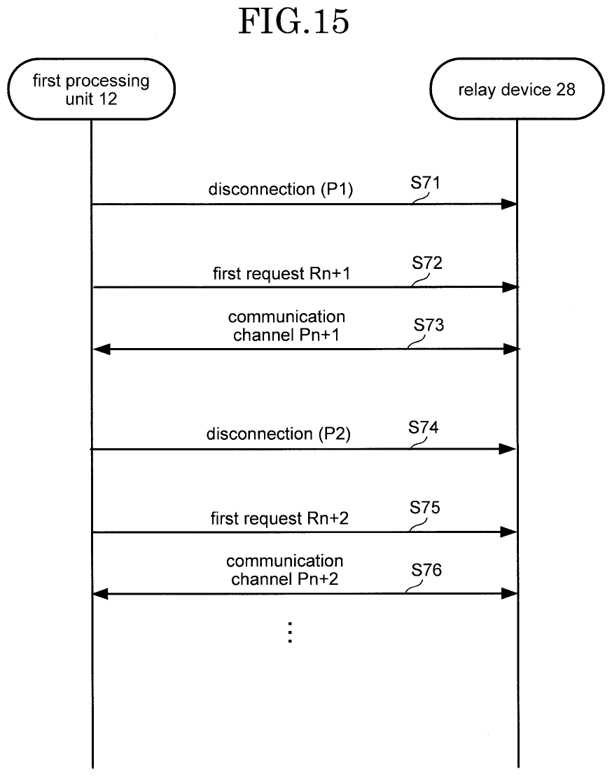

FIG. 15 is a sequence chart showing an example of the flow of a communication channel management process that is executed by the communication system according to the present modification. In a case where the first processing unit 12 has disconnected any of the communication channels, the first processing unit 12 transmits a first request to the relay device 28 for the establishment of a new communication channel. For example, in a case where HTTP 1.0 is employed, the first processing unit 12 disconnects the communication channel P1 with the relay device 28 after completion of step S68 shown in FIG. 14 (step S71). In this case, the first processing unit 12 transmits a first request Rn+1 to the relay device 28 for the establishment of a new communication channel (step S72). In response to the first request Rn+1, a communication channel Pn+1 is established between the router 10 and the relay device 28 (step S73). Similarly, the first processing unit 12 disconnects the communication channel P2 with the relay device 28 after completion of step S70 shown in FIG. 14 (step S74). In this case, the first processing unit 12 transmits a first request Rn+2 to the relay device 28 for the establishment of a new communication channel (step S75). In response to the first request Rn+2, a communication channel Pn+2 is established between the router 10 and the relay device 28 (step S76). In the subsequent steps, too, the first processing unit 12 transmits a first request to the relay device 28 in a case where a communication channel between the router 10 and the relay device 28 has been disconnected.

As described above, communication channels are kept established between the router 10 and the relay device 28. This makes it take a shorter period of time (e.g. round-trip time) to transfer content than in a case where the first processing unit 12 establishes a new communication channel by transmitting a first request every time the transfer of content is performed in response to one second request.

In a communication device of the present invention, there needs to be no distinction between a transmitting unit that transmits a first request and a transmitting unit that transmits a second request. That is, a transmitting unit may transmit a first request and transmit a second request.

A communication device of the present invention does not need to have a function of providing content. For example, this communication device may receive a second request and transfer the second request to a content providing device that provides content corresponding to the second request.

An information processing system of the present invention is identified by a combination of a router 10 and a relay device 28 as well as a combination of a router 10 and a management system 200. In this case, the relay device 28 may have at least some of the functions of the management system 200.

A first request is not limited to a request for the establishment of a TCP session as a communication channel. For example, TCP may be replaced by UDP (User Datagram Protocol). Further, a communication channel is not limited to a communication channel that is established by processing of a session layer. A communication channel may for example be a communication channel that is established by processing a layer (e.g. an application layer) other than a session layer. A second request is not limited to an HTTP request. Further, the second processing unit 14, which transmits an HTTP response containing content, may also transmit content under a non-HTTP protocol. Examples of non-HTTP protocols include TELNET (Teletype Network) and SSH (Secure Shell). Further, in the communication system 1, various types of processing may be performed under protocols other than the HTTP protocol.

A communication channel that is used in the transmission of content may be established separately from a communication channel that is used in the transmission of a first request and a second request. In this case, in the communication system 1, content may be transferred without going through the information processing system 20. That is, the relay device 28 does not need to have the third transfer unit 2810. Further, the management system 200 does not need to have the fourth transfer unit 2012.

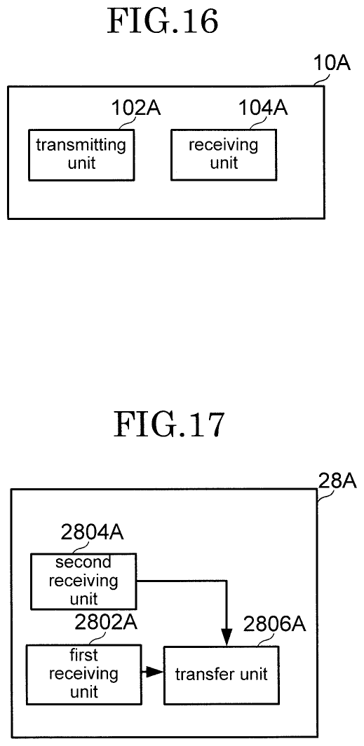

A communication device according to the present invention can be identified as a communication device 10A configured as shown in FIG. 16. That is, the communication device 10A includes a transmitting unit 102A and a receiving unit 104A. The transmitting unit 102A transmits, to a relay device configured to relay communication between a client and the communication device, a first request for the establishment of a communication channel with the communication device. The receiving unit 104A receives a second request transmitted by the client from the relay device through the communication channel thus established.

Another communication device according to the present invention includes a first transmitting unit configured to transmit, to a relay device configured to relay communication between a client and the communication device, a first request for the establishment of a communication channel with the communication device, a receiving unit configured to receive a second request for content transmitted by the client from the relay device through the communication channel thus established, and a second transmitting unit configured to transmit, to the relay device, content corresponding to the second request thus received. Upon receiving the second request, the receiving unit establishes a communication channel with the second transmitting unit. The second transmitting unit transmits the content through a communication channel with the first transmitting unit.

A relay device according to the present invention can be identified as a relay device 28A configured as shown in FIG. 17. That is, the relay device 28A is a relay device that relays communication between a client and a communication device, and includes a first receiving unit 2802A, a second receiving unit 2804A, and a transfer unit 2806A. The first receiving unit 2802A receives a first request from the communication device for the establishment of a communication channel with the communication device. The second receiving unit 2804A receives a second request transmitted by the client. The transfer unit 2806A transfers the second request thus received to the communication device through the communication channel thus established.

Further, in a case where the functions of each of the devices described above are achieved by using a program, this program may be provided in a state of being stored on a computer-readable recording medium such as a magnetic recording medium (such as a magnetic tape or a magnetic disk), an optical recording medium, a magneto-optical recording medium, or a semiconductor memory or may be distributed via a network. Further, the present invention may also be construed as a method invention (communication method, relay method, information processing method).

It should be noted that the present invention is not limited to the embodiments described above but may be changed as appropriate without departing from the scope of the present invention.

What is claimed is:

1. A communication system, comprising:
a storage device;
a management device configured to communicate with the storage device;
a transfer device configured to communicate with the management device;
a relay device configured to communicate with the transfer device; and
a router configured to communicate with the relay device, the router has one or more processors and one or more memories having program instructions stored thereon executable by the one or more processors to cause the router to:
transmit, to the relay device configured to relay communication between a client and the router, a first request for establishment of a communication channel with the router;
receive a second request for content transmitted by the client from the relay device through the communication channel thus established;
obtain content corresponding to the second request from a memory having content stored thereon, and
transmit, to the relay device, content corresponding to the second request through the communication channel established with the relay device.

2. A communication device comprising:
one or more processors; and
one or more memories having program instructions stored thereon executable by the one or more processors to cause the communication device to:
transmit, to a relay device configured to relay communication between a client and the communication device, a first request for establishment of a communication channel with the communication device;
receive a second request for content transmitted by the client from the relay device through the communication channel thus established;
obtain content corresponding to the second request from a memory having content stored thereon, and
transmit, to the relay device, content corresponding to the second request through the communication channel established with the relay device.

3. The communication device according to claim 2, wherein program instructions are further executable by the one or more processors to cause the communication device to transmit the first request upon activation of the communication device.

4. The communication device according to claim 2, wherein the communication channel established with the relay device goes through a firewall.

5. The communication device according to claim 2, wherein program instructions are further executable by the one or more processors to cause the communication device to transfer data between a first network and a second network, and
transmit content pertaining to a function of the data transmission between the first network and the second network.

6. The communication device according to claim 5, wherein the first network is an intranet, and
the second network is the Internet or a WAN (wide area network).

7. The communication device according to claim 2, wherein the first request is a request for establishment of a TCP (Transmission Control Protocol) session as the communication channel, and
the second request is an HTTP (Hypertext Transfer Protocol) request.

8. The communication device according to claim 2, wherein the communication device is a router.

9. The communication device according to claim 8, wherein the router has an HTTPD (HTTP daemon).

10. The communication device according to claim 2, wherein the content contains an image taken by a camera.

11. The communication device according to claim 2, wherein program instructions are further executable by the one or more processors to cause the communication device to transmit a plurality of the first requests to the relay device and, in a case where any of a plurality of communication channels established with the relay device has been disconnected, transmit the first request.

12. A relay device for relaying communication between a client and a communication device, the relay device comprising:
one or more processors; and
one or more memories having program instructions stored thereon executable by the one or more processors to cause the relay device to:
receive a first request from the communication device for establishment of a communication channel with the communication device;
receive a second request transmitted by the client; and
transfer the second request thus received to the communication device through the communication channel in a case where it is determined that the second request is transferable.

13. The relay device according to claim 12, further comprising a correspondence relationship storage memory storing data indicating a correspondence relationship between each of a plurality of the communication devices and a communication channel established between the relay device and the communication device, wherein
program instructions are further executable by the one or more processors to cause the relay device to select the communication channel for use in transfer of the second request on the basis of identification information of the communication device contained in the second request and the correspondence relationship.

14. The relay device according to claim 12, wherein program instructions are further executable by the one or more processors to cause the relay device to transfer the second request after the communication channel has been established when the communication channel has not yet been established in a case where the second request has been received.

15. An information processing system comprising:
the relay device according to claim 12;
a login information storage memory storing login information;
one or more processors; and
one or more memories having program instructions stored thereon executable by the one or more processors to cause the information processing system to:
receive login information from the client;
receive the second request from the client;
determine, on the basis of the second request received from the client and login information thus stored, whether transfer of the second request to the relay device is possible or impossible; and
transfer the second request thus received to the relay device, in a case where it is determined that the transfer is possible.

16. A communication system comprising:
a communication device having one or more processors and one or more memories having program instructions stored thereon executable by the one or more processors to cause the communication device to:
transmit, to a relay device configured to relay communication between a client and the communication device, a first request for establishment of a communication channel with the communication device;
receive a second request for content transmitted by the client from the relay device through the communication channel thus established;
obtain content corresponding to the second request from a memory having content stored thereon, and
transmit, to the relay device, content corresponding to the second request through the communication channel established with the relay device; and
the relay device according to claim 12.

17. A communication system comprising:
a communication device having one or more processors and one or more memories having program instructions stored thereon executable by the one or more processors to cause the communication device to:
transmit, to a relay device configured to relay communication between a client and the communication device, a first request for establishment of a communication channel with the communication device;
receive a second request for content transmitted by the client from the relay device through the communication channel thus established;
obtain content corresponding to the second request from a memory having content stored thereon, and
transmit, to the relay device, content corresponding to the second request through the communication channel established with the relay device; and
the information processing system according to claim 15.

18. A method for communication, comprising:
transmitting, to a relay device configured to relay communication between a client and a communication device, a first request for establishment of a communication channel with the communication device;
receiving a second request for content transmitted by the client from the relay device through the communication channel thus established;
obtaining content corresponding to the second request from a memory having content stored thereon, and
transmitting, to the relay device, content corresponding to the second request through the communication channel established with the relay device.

19. A communication device comprising:
one or more processors; and
one or more memories having program instructions stored thereon executable by the one or more processors to cause the communication device to:
transmit, to a relay device configured to relay communication between a client and the communication device, a first request for establishment of a communication channel with the communication device; and
receive a second request transmitted by the client from the relay device through the communication channel thus established.

20. The communication device according to claim 19, wherein program instructions are further executable by the one or more processors to cause the communication device to transmit the first request upon activation of the communication device.

21. The communication device according to claim 19, wherein the communication channel goes through a firewall.
